(19) United States
(12) Patent Application Publication
(10) Pub. No.: US 2005/0286462 A1
(43) Pub. Date: Dec. 29, 2005

(54) OFDM symbol transmission method and apparatus for providing sector diversity in a mobile communication system, and system using the same

(75) Inventors: Hee-Jin Roh, Suwon-si (KR); Min-goo Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/165,185

(22) Filed: Jun. 24, 2005

(30) Foreign Application Priority Data
Jun. 25, 2004 (KR) 2004-48280

(51) Int. Cl. H04Q 7/00

(52) U.S. Cl. 370/328

(57) ABSTRACT

An orthogonal frequency division multiplexing (OFDM) system with a multicell or multisector structure includes a plurality of base stations and mobile stations. Each of the base stations interleaves data for transmission to the mobile station, performs space-time coding (STC) on the interleaved data into a plurality of space-time code streams, selects one of the space-time code streams every predetermined code stream selection period such that different space-time code streams are transmitted to at least one cell or sector from among cells or sectors formed by the base station and other base stations, and outputs the selected space-time code stream as an OFDM symbol. Each of the mobile stations STC-decodes a space-time code stream obtained by performing Fourier transform on the OFDM symbol, deinterleaves the STC-decoded data, and channel-decodes the deinterleaved data into its original data.

### PRIORITY

This application claims the benefit under 35 U.S.C. §119(a) of an application entitled “OFDM Symbol Transmission Method and Apparatus for Providing Sector Diversity in a Mobile Communication System, and System Using the Same” filed in the Korean Intellectual Property Office on Jun. 25, 2004 and assigned Serial No. 2004-48280, the entire contents of which are hereby incorporated by reference.

### BACKGROUND OF THE INVENTION

1. Field of the Invention

The present invention relates generally to a method and apparatus for transmitting Orthogonal Frequency Division Multiplexing (OFDM) symbols in an OFDM mobile communication system. In particular, the present invention relates to an OFDM symbol transmission method and apparatus for providing sector diversity and improving a frame error rate (FER) and a bit error rate (BER) in a mobile communication system with a multicell structure, and a system using the same.

2. Description of the Related Art

A wireless communication system employing an Orthogonal Frequency Division Multiplexing (OFDM) transmission scheme is one of the typical wireless mobile communication systems employing a multicarrier transmission scheme. The OFDM transmission scheme converts a serial input symbol stream into parallel symbols and modulates the parallel symbols with multiple orthogonal subcarriers prior to transmission, and has become popular since the early 1990s with the development of Very Large Scale Integration (VLSI) technology.

The OFDM transmission scheme modulates data using multiple subcarriers, each of which maintains orthogonality with the other subcarriers. Therefore, compared with the conventional single-carrier modulation scheme, the OFDM transmission scheme exhibits a robust characteristic against a frequency selective multipath fading channel.

This is because from a mobile station's point of view, the frequency selective multipath fading channel becomes a frequency selective channel in the full frequency band but becomes a frequency nonselective channel in each subcarrier band, so that the mobile station can perform channel compensation on the frequency selective multipath fading channel through a simple channel equalization process.

In addition, the OFDM transmission scheme attaches a cyclic prefix symbol (CP) obtained by copying a rear part of each OFDM symbol to the header of the OFDM symbol prior to transmission, thereby removing intersymbol interference (ISI) from a previous symbol. This robust characteristic against the multipath fading channel enables the OFDM transmission scheme to be suitable for high-speed wideband communication.

Therefore, in a broadcast service standard for the wireless mobile communication system, the OFDM transmission scheme is a potential transmission scheme capable of guaranteeing high reception quality and high-speed transmission and reception. The broadcast service standards adopting the OFDM transmission scheme includes Digital Audio Broadcasting (DAB) for European wireless radio broadcasting, and Terrestrial Digital Video Broadcasting (DVB-T), which is a terrestrial High Definition Television (HDTV).

FIG. 1 is a diagram illustrating a structure of the conventional wireless mobile communication system employing the OFDM scheme. Referring to FIG. 1, a modulator 110 in each of base stations (BSs) 100₁ to 100_{M} modulates data to be transmitted to a mobile station (MS) 200 with a predetermined modulation scheme, and outputs the modulated data to an inverse fast Fourier transform block (IFFT) 120. The IFFT 120 performs inverse fast Fourier transform on the modulated data to convert the modulated data into time-domain data, and outputs the IFFT-processed data to a CP adder 130. The CP adder 130 attaches a cyclic prefix symbol (CP) to the IFFT-processed data and outputs an OFDM symbol. The OFDM symbol is transmitted to a wireless network via an antenna 140.

The mobile station 200 receives an OFDM symbol received at a sector where it is located, via an antenna 210. In the mobile station 200, a CP remover 220 detaches a CP from the received OFDM symbol, and delivers the CP-detached OFDM symbol to a fast Fourier transform block (FFT) 230. The FFT 230 performs fast Fourier transform on the OFDM symbol to convert the OFDM symbol into a frequency-domain signal, and outputs the FFT-processed OFDM symbol to a demodulator 240. The demodulator 240 demodulates the FFT-processed OFDM symbol according to a predetermined demodulation scheme. As described above, the general OFDM system can be simply implemented using the IFFT 120 and the FFT 230 such that data is transmitted and received with multiple subcarriers.

In the OFDM system having a multicell and or multisector structure, when multiple base stations transmit data using the same subcarriers and different data is transmitted through the subcarriers, interference typically occurs between transmission data at a boundary of each sector, causing serious performance deterioration.

In this context, an Orthogonal Frequency Division Multiple Access (OFDMA) scheme, which is a multiple access scheme capable of accommodating a plurality of users taking both time and frequency into consideration, is preferable for a system having an interference problem at the sector boundary, such as a Wireless Local Area Network (WLAN) system and a Wireless Metropolitan Area Network (WMAN) system. Currently, the standards for IEEE 802.16d and 2.3 GHz portable Internet, also known as Wireless Broadband Internet (WiBro), fully consider adopting the OFDMA scheme.

In the conventional WLAN and WMAN systems, when different data from base stations is transmitted through the same subcarriers, the data received from the undesired base stations at a sector boundary serves as an interference component to the data X[k] transmitted from a desired base station as shown in Equation (1) below.

$$Y [ k ] = H [ k ] X [ k ] + ( {\sum }_{i = 2}^{L} {H}_{i} [ k ] ) {X}_{i} [ k ] + W [ k ] \qquad Equation ( 1 )$$

where Y[k] denotes a signal received at a mobile station through a k^{th} subcarrier, Hᵢ[k] denotes a channel component of a signal received from an i^{th} base station through a k^{th} subcarrier, W[k] denotes a noise component of a k^{th} subcarrier, and L denotes the number of sectors around the mobile station.

In Equation (1), a second term serves as an intersector interference component for a first term indicating the data that the mobile station desires to receive. Because the intersector interference component deteriorates bit error rate (BER) performance, it is preferable to use the OFDMA scheme rather than the OFDM scheme for reducing a mean interference component by the multiple access scheme.

When a broadcast system employing the OFDM transmission scheme uses a single frequency network (SFN) and a plurality of base stations 100 transmit the same data as shown in FIG. 1, data transmitted from the different base stations is received at the mobile station 200 as the same data with a mere difference in reception delay and channel gain. Therefore, no interference component occurs in the sector boundary unlike in the case where different data is transmitted from the base stations.

Equation (2) shows an FFT output signal of the mobile station 200 assuming that the same data X[k] is transmitted from the different base stations through a k^{th} subcarrier.

$$Y [ k ] = ( {\sum }_{i = 1}^{L} {H}_{i} [ k ] ) {X}_{i} [ k ] + W [ k ] \qquad Equation ( 2 )$$

In Equation (2), because a signal received from a neighboring base station corresponds to the same transmission signal X[k] transmitted through a channel Hᵢ[k], no intersector interference occurs unlike in Equation (1). In particular, when a mobile station is located at a sector boundary, signals received from the base stations are similar to each other in strength in Equation (2), thereby increasing the number L of sectors around the mobile station. However, when the mobile station is located in the vicinity of a base station, the value of the L decreases.

As can be understood from the received signal of Equation (2), in the conventional technology, channel components from the base stations to the mobile station in the FFT output signal of the mobile station are shown in the combined form rather than being separated.

Therefore, a receiver of the mobile station cannot use diversity combining because it cannot distinguish the channel components transmitted from the base stations, making it difficult to sufficiently acquire a diversity gain between sectors, especially when the mobile station is located in the sector boundary. In addition, because broadcast data transmitted from the base stations to the mobile station is not power-controlled, the broadcast data, even though it has no interference component, decreases in its reception power in a sector or cell boundary, causing performance deterioration.

### SUMMARY OF THE INVENTION

It is, therefore, an object of the present invention to provide an orthogonal frequency division multiplexing (OFDM) symbol transmission method and apparatus for providing improved sector diversity in a mobile communication system, and a system using the same.

It is another object of the present invention to provide an OFDM symbol transmission method and apparatus for providing uniform sector diversity in a broadcast system employing an OFDM transmission scheme, and a system using the same.

According to one aspect of the present invention, there is provided a method for transmitting by a base station an orthogonal frequency division multiplexing (OFDM) symbol to a mobile station in a wireless mobile communication system with a multicell and or multisector structure formed by a plurality of base stations. The method comprises the steps of interleaving data for transmission to the mobile station; space-time coding (STC) the interleaved data and outputting a plurality of space-time code streams; and selecting one of the space-time code streams every predetermined code stream selection period such that different space-time code streams are transmitted to at least one neighboring cell or sector from among cells and sectors formed by the base station and other base stations, and transmitting the selected space-time code stream.

According to another aspect of the present invention, there is provided an apparatus for transmitting by a base station an orthogonal frequency division multiplexing (OFDM) symbol to a mobile station in a wireless mobile communication system with a multicell and or multisector structure formed by a plurality of base stations. The apparatus comprises an interleaver for interleaving data for transmission to the mobile station; an space-time coding (STC) encoder for STC-coding the interleaved data and outputting a plurality of space-time code streams; a selector for selecting one of the space-time code streams every predetermined code stream selection period such that different space-time code streams are transmitted to at least one neighboring cell or sector from among cells and sectors formed by the base station and other base stations; and a transmitter for generating an OFDM symbol using the space-time code stream output from the selector and transmitting the OFDM symbol to a wireless network.

According to further another aspect of the present invention, there is provided an apparatus for receiving by a mobile station an orthogonal frequency division multiplexing (OFDM) symbol from a base station in a wireless mobile communication system with a multicell and or multisector structure formed by a plurality of base stations. The apparatus comprises a space-time coding (STC) decoder for STC-decoding a space-time code stream obtained by performing a Fourier transform on the OFDM symbol; a deinterleaver for deinterleaving the STC-decoded data; and a channel decoder for channel-decoding the deinterleaved data into its original data.

According to another further aspect of the present invention, there is provided an orthogonal frequency division multiplexing (OFDM) system with a multicell and or multisector structure. The system comprises a plurality of base stations each including interleaving data for transmission to the mobile station, space-time coding (STC) the interleaved data into a plurality of space-time code streams, selecting one of the space-time code streams every predetermined code stream selection period such that different space-time code streams are transmitted to at least one neighboring cell or sector from among the cells and sectors formed by the base station and other base stations, and outputting the selected space-time code stream as an OFDM symbol; and at least one mobile station for STC-decoding a space-time code stream obtained by performing a Fourier transform on the OFDM symbol, deinterleaving the STC-decoded data, and channel-decoding the deinterleaved data into its original data.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a structure of a conventional wireless mobile communication system employing an orthogonal frequency division multiplexing (OFDM) scheme;

FIG. 2 is a block diagram for a description of a general space-time coding technique;

FIG. 3 is a block diagram illustrating an internal structure of an OFDM symbol transmission apparatus capable of providing sector diversity according to an embodiment of the present invention;

FIGS. 4A and 4B are block diagrams illustrating different examples of space-time code streams output from the STC encoder of FIG. 3;

FIG. 5 is a block diagram illustrating an internal structure of an OFDM symbol reception apparatus capable of providing sector diversity according to an embodiment of the present invention;

FIGS. 6, 7 and 8 are diagrams for a description of a per-sector space-time code stream arrangement method according to an embodiment of the present invention;

FIGS. 9, 10 and 11 are diagrams for a description of a per-cell space-time code stream arrangement method according to an embodiment of the present invention;

FIG. 12 is a flowchart illustrating an OFDM symbol transmission method for providing sector diversity according to an embodiment of the present invention;

FIG. 13 is a flowchart illustrating an OFDM symbol reception method for providing sector diversity according to an embodiment of the present invention;

FIG. 14 is a block diagram illustrating another example of the channel encoder illustrated in FIG. 3; and

FIG. 15 is a block diagram illustrating another example of the channel decoder illustrated in FIG. 5.

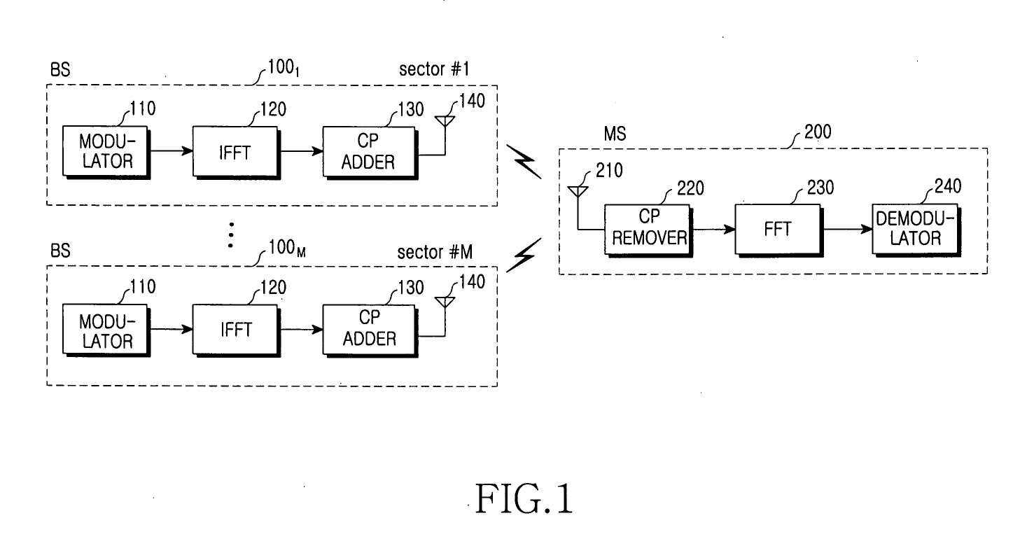

Throughout the drawings, the same or similar elements are denoted by the same reference numerals.

### DETAILED DESCRIPTION OF EXEMPLARY EMBODIMENTS

Several embodiments of the present invention will now be described in detail with reference to the accompanying drawings. In the following description, a detailed description of known functions and configurations incorporated herein has been omitted for conciseness.

Before a description of embodiments of the present invention is given, a basic concept of the present invention will be described in brief.

The foregoing assumption that the same broadcast data is transmitted to a plurality of sectors formed by base stations in a wireless mobile communication system employing the orthogonal frequency division multiplexing (OFDM) transmission scheme can be fully achieved because the base stations can transmit the same data under the control of a base station controller. However, when the same data, like the broadcast data, is broadcast in each sector, signals transmitted from each base station to a mobile station are not subject to power control. Therefore, even though there is no interference component, reception power of the signals can be attenuated at a cell or sector boundary, causing performance degradation.

Therefore, embodiments of the present invention provide a scheme for enabling a mobile station to obtain a sector diversity gain by applying space-time coding (STC), which is one of a variety of transmit diversity techniques, to the signals transmitted in each sector in order to improve the reception performance of the mobile station at a cell or sector boundary.

To this end, embodiments of the present invention provide a sector structure in which the sector diversity gain of a mobile station can be improved, and provides a method for periodically selecting one of space-time code streams output from each base station using a per-sector space-time code stream arrangement method suitable for the proposed sector structure. As the space-time code stream is an orthogonal code stream, a selection period of the space-time code stream will be referred to as a “code stream selection period.”

According to embodiments of the present invention, a base station performs interleaving of transmission data in units of a multiple of the code stream selection period before an STC coding process, and a mobile station performs deinterleaving of the received data in units of a multiple of the code stream selection period after a STC decoding process. In this manner, a receiver converts an improved average sector diversity gain into an instantaneously uniform sector diversity gain, thereby improving frame error rate (FER) and BER performances.

That is, embodiments of the present invention primarily uniformly distribute sector diversity gain that may be irregularly generated in a period where space-time code streams are selected, by performing interleaving and deinterleaving in units of the code stream selection period, and secondarily distributes sector diversity gain to all of mobile stations at a cell and or sector boundary instead of concentrating the sector diversity gain to a mobile station located in a particular position, by periodically selecting one of space-time code streams for every sector belonging to a base station and transmitting the selected space-time code stream. The embodiments of the present invention provide sector diversity gain to the mobile stations in this manner.

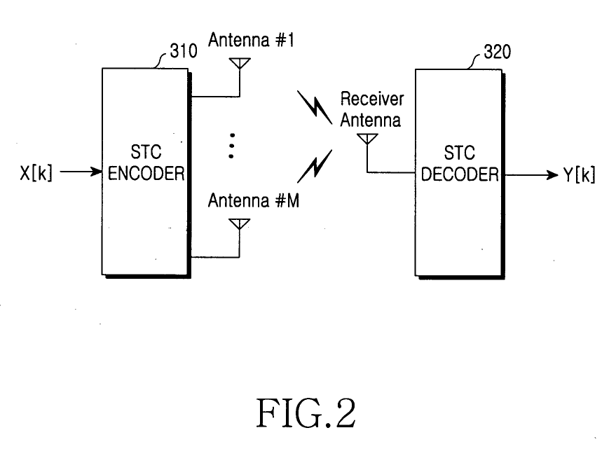

For a better understanding of the embodiments of the present invention, the space-time coding technique will be briefly described below with reference to FIG. 2.

Referring to FIG. 2, in the space-time coding technique, an STC encoder 310 STC-encodes a series of complex symbols X[k] into a plurality of parallel data symbol streams and transmits the parallel data symbol streams to a mobile station using a plurality of transmission antennas Antenna#1 to Antenna#M. The mobile station receives data transmitted from the transmission antennas Antenna#1 to Antenna#M via its antenna, and an STC decoder 320 in the mobile station STC-decodes the received data into its original data Y[k]. A transmit diversity gain is acquired through such a transmission process. Although a plurality of transmission antennas are connected to an output terminal of the STC encoder 310 illustrated in FIG. 2, by way of example, for a description of the space-time coding technique, the STC encoder 310 can be separately provided to each of sectors formed by each base station and at least one sector is formed in a cell formed by each base station.

The space-time coding technique includes a space-time block coding scheme implemented using a simple encoder/decoder structure, such as an Alamouti space-time block coding scheme, which is one of the more popularly used space-time coding techniques. The Alamouti space-time block coding scheme encodes two input complex symbols and transmits the coded space-time streams using, for example, two transmission antennas. Herein, a space-time code stream coded by the Alamouti space-time coding scheme corresponds to an orthogonal code that uses complex symbols as an input and satisfies a coding rate of 1 and has full diversity.

The embodiment of the novel method described below can be used for transmission and reception of downlink data for a broadcast service based on the OFDM transmission scheme in a code division multiple access 2000 (CDMA2000) first evolution-data only (1x EV-DO) standard, which is a 3^{rd} generation (3G) synchronous network standard. In the near future, if a wideband code division multiple access (WCDMA) cellular system provides a broadcast service using the OFDM transmission scheme, the embodiments of the novel method can be applied thereto in the same manner. That is, it should be noted that embodiments of the present invention can be used together with the OFDM transmission technique if the base stations can transmit the same data as a cellular system that includes such a unit as the base station controller.

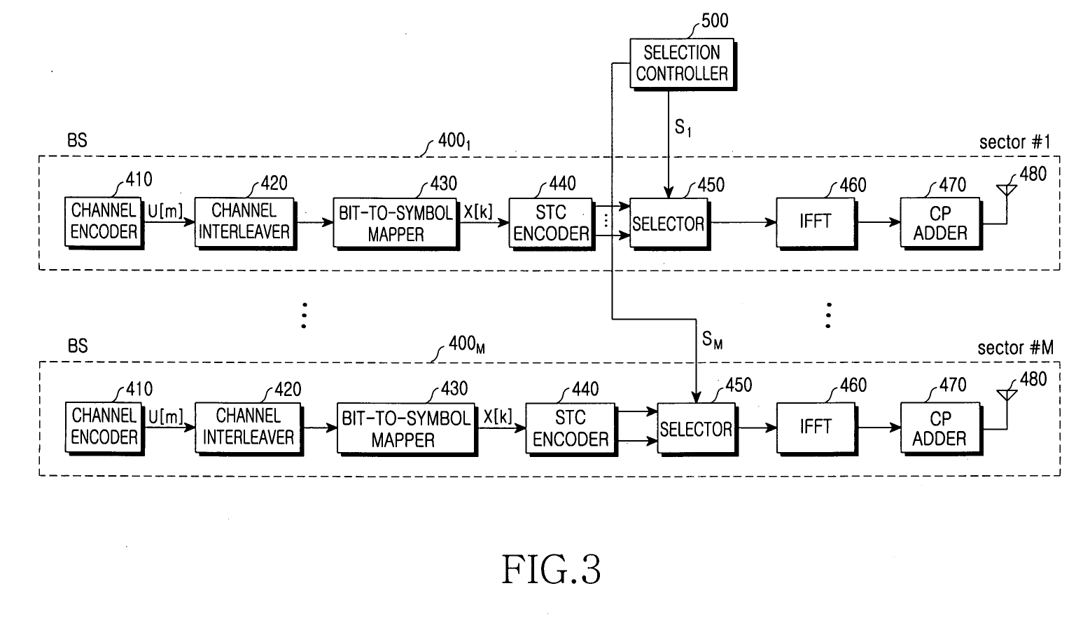

FIG. 3 is a block diagram illustrating an internal structure of an OFDM symbol transmission apparatus capable of providing sector diversity according to an embodiment of the present invention. The OFDM symbol transmission apparatus has a multicell or multisector structure, and is included in a base station apparatus for transmitting signals with the OFDM transmission scheme. It is assumed that the base station apparatus of FIG. 3 can transmit the same data to different cells or sectors in, for example, a broadcast service.

In FIG. 3, Sector#1 to Sector#M represent devices for distinguishing different base stations or a plurality of sectors belonging to the same base station. Each base station preferably includes at least one OFDM symbol transmission apparatus 400 to transmit space-time code streams per sector according to a pattern predetermined for each cell. Such a structure is possible because even the sectors belonging to different base stations can receive the same data from a base station controller (not shown) and transmit the received data to a mobile station.

If a pattern formed by the space-time code streams changes in units of cells, it is possible to select one of the space-time code streams in the units of cells and transmit the selected space-time code stream. Herein, the pattern changes selection of space-time code streams transmitted per cell or sector according to a predetermined time period, thereby improving cell or sector diversity at a cell or sector boundary. A detailed description of the pattern formed by the space-time code streams will be made below.

The process of periodically selecting one of the space-time code streams per cell or sector according to the pattern formed in units of at least one cell and transmitting the selected space-time code stream uniforms cell or sector diversity in a cell or sector boundary. Therefore, it is assumed herein that the sector diversity covers the cell diversity.

When the same data is simply transmitted through different sectors, the mobile station cannot acquire a sufficient diversity gain at a cell or sector boundary as described with reference to Equation (2). Therefore, the OFDM symbol transmission apparatus 400 includes a channel interleaver 420, an STC encoder 440, and a selector 450 in order to provide uniform sector diversity gain at a cell or sector boundary in the process of transmitting the same data and to improve PER and BER performances in the mobile station. The selector 450 controls an output pattern of space-time code streams under the control of a selection controller 500.

A structure of the OFDM symbol transmission apparatus 400 will now be described in more detail with reference to FIG. 3.

In a base station, a channel encoder 410 generates transmission data U[m] (where m=1,2, . . . ,N) for sectors Sector#1 to Sector#M, respectively. The transmission data U[m] channel-coded by the channel encoder 410 is interleaved by the channel interleaver 420 having a length N, and is output to a bit-to-symbol mapper 430. The length N of the channel interleaver 420 means the number of bits of transmission data transmitted for a time corresponding to a multiple of the code stream selection period. The channel encoder 410 can be followed by a repeater or puncturer (not shown) to adjust a coding rate of the transmission data by repeating or puncturing the interleaved data.

The bit-to-symbol mapper 430 converts output bit streams of the channel interleaver 420 into complex symbols X[k], and delivers the complex symbols X[k] to the STC encoder 440. The bit-to-symbol mapper 430 can use one of either binary phase shift keying (BPSK), quadrature phase shift keying (QPSK), M-ary phase shift keying (M-ary PSK), and M-ary quadrature amplitude modulation (M-ary QAM). Although the channel interleaver 420 is connected to an input terminal of the bit-to-symbol mapper 430 by way of example, the channel interleaver 420 can also be connected to an output terminal of the bit-to-symbol mapper 430. In this case, the channel-coded transmission data is converted into complex symbols and then undergoes per-symbol interleaving.

The complex symbols X[k] output from the bit-to-symbol mapper 430 are delivered to the STC encoder 440, and the STC encoder 440 STC-encodes the input complex symbols with, for example, the Alamouti space-time coding scheme and outputs the space-time code streams before transmitting IFFT-processed OFDM symbols to each sector.

The selector 450 selects one of a plurality of space-time code streams acquired through the space-time coding, and transmits the selected space-time code stream to a corresponding sector. Herein, the selector 450 under the control of a selection controller 500 selects one of the space-time code streams output from the STC encoder 440 and outputs the selected signal to an inverse fast Fourier transform block (IFFT) 460. Although it is preferable that the selection controller 500 controls the selector 450 included in each OFDM symbol transmission apparatus 400 and is included in a base station controller (not shown), the selection controller 500 can also be combined with the selector 450 or individually included in each base station.

The IFFT 460 performs an IFFT on data to be transmitted to the mobile station to convert the transmission data into time-domain data, and outputs the IFFT-processed data to a CP adder 470. The CP adder 470 attaches a cyclic prefix symbol (CP) to the IFFT-processed OFDM data and outputs an OFDM symbol. The OFDM symbol is transmitted to a corresponding one of the sectors Sector#1 to Sector#M via an antenna 480.

In the structure of FIG. 3, if a transmitter of the base station performs a modulation process using an IFFT, a receiver of the mobile station performs a demodulation process using fast Fourier transform (FFT). Alternatively, the transmitter of the base station can perform the modulation process using FFT, and in this case, the receiver of the mobile station performs the demodulation process using IFFT. For convenience, it will be assumed herein that the IFFT and the FFT are used for modulation and demodulation, respectively, as shown in FIG. 3.

A detailed description will now be made of a space-time coding scheme performed in the STC encoder 440.

Herein, the STC encoder 440 preferably uses the Alamouti space-time coding scheme, and is designed to receive two complex symbols and output two different coded symbol streams, also referred to as space-time code streams, and its coding matrix C is defined as a 2×2 matrix as shown in Equation (3) below.

$$C = [ \begin{matrix}{X}_{1} & {X}_{2} \\ - {X}_{2}^{*} & {X}_{1}^{*}\end{matrix} ] \qquad Equation ( 3 )$$

where X₁ and X₂ denote complex symbols input to the STC encoder 440.

The STC encoder 440 outputs two different space-time code streams in accordance with Equation (3).

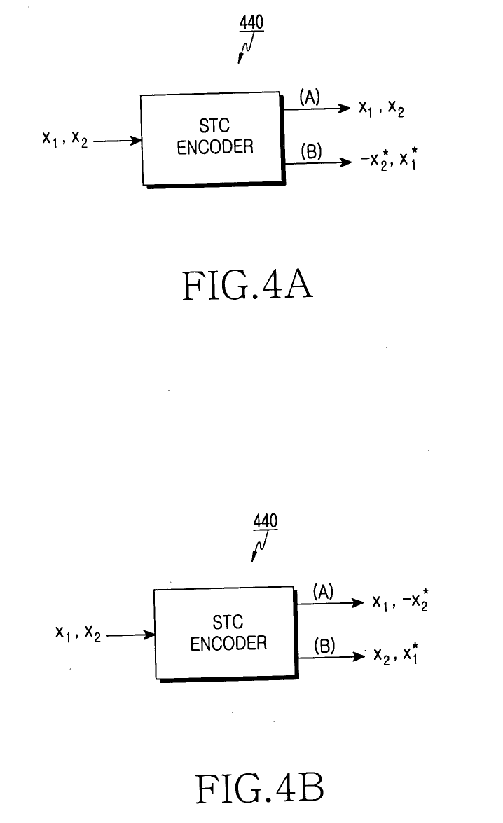

FIGS. 4A and 4B are diagrams illustrating different examples of space-time code streams output from the STC encoder 440 of FIG. 3. Specifically, FIG. 4A illustrates a space-time code stream (A) of {X₁, X₂} and a space-time code stream (B) of {−X₂*, X₁*}, which are output on the basis of row vectors of the coding matrix C, and FIG. 4B illustrates a space-time code stream (A) of {X₁, −X₂*} and a space-time code stream (B) of {X₂, X₁*}, which are output on the basis of column vectors of the coding matrix C. Every sector can use either the STC encoder 440 of FIG. 4A or the STC encoder 440 of FIG. 4B. One of the space-time code streams (A) and (B) is selected by the selector 450 under the control of the selection controller 500 that determines which space-time code stream it will select and transmit in each sector.

The space-time code streams output to multiple cells or sectors under the control of the selection controller 500 have a specific pattern. The selection controller 500 performs output selection on the space-time code streams every predetermined periodic or non-periodic code stream selection period such that uniform sector diversity gain occurs in all of the mobile stations.

Although the output selection on the space-time code streams is controlled herein by the selection controller 500, it is also possible that the selector 450 receives a separate parameter value from an upper layer and directly controls an output pattern of the space-time code streams according to the parameter value.

It should be noted that a receiver of the mobile station can restore data using one STC decoder without being affected by a variation in the space-time code stream.

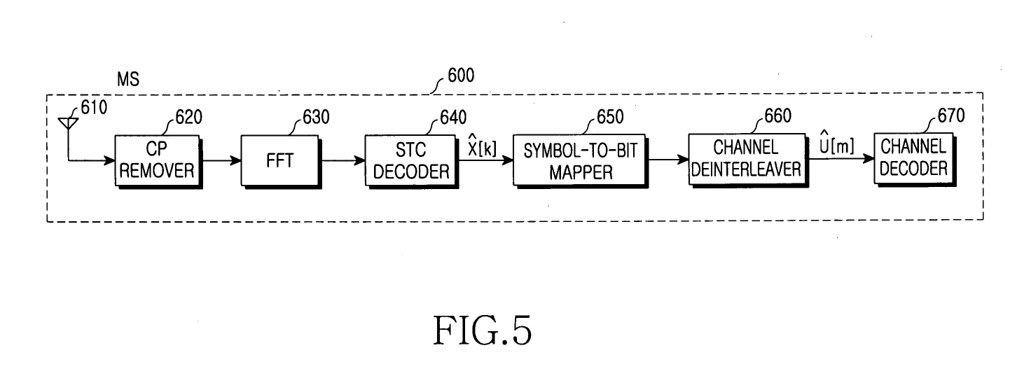

FIG. 5 is a block diagram illustrating an internal structure of a mobile station receiver 600 for receiving OFDM symbols transmitted from the OFDM symbol transmission apparatus 400 of FIG. 3. Referring to FIG. 5, the receiver 600 receives OFDM symbols transmitted from a plurality of cells or sectors through an antenna 610 at a cell or sector boundary. A CP remover 620 removes a CP from the received OFDM symbol, and outputs the CP-removed OFDM symbol to a fast Fourier transform block (FFT) 630. The FFT 630 converts the received OFDM symbol into a frequency-domain signal, and outputs the frequency-domain signal to an STC decoder 640. The STC decoder 640 decodes the space-time code stream encoded with, preferably, the Alamouti space-time coding scheme, and outputs a decoded complex symbol \hat{X}[k]. A symbol-to-bit mapper 650 converts the decoded complex symbol into a bit stream, and outputs the bit stream to a channel deinterleaver 660. The channel deinterleaver 660 performs channel deinterleaving on the input bit stream at the same period as that in the channel interleaver 420 of the OFDM symbol transmission apparatus 400. For the reception data Û[m] (where m=1,2, . . . ,N) output from the channel deinterleaver 660, N denotes the number of bits of the deinterleaved reception data received for a time corresponding to a multiple of the code stream selection time period.

The output of the channel deinterleaver 660 is delivered to a channel decoder 670, and the channel decoder 670 decodes the reception data. Although not illustrated in FIG. 5, if the OFDM symbol transmission apparatus 400 performs per-symbol interleaving, the receiver 600 of the mobile station should also perform per-symbol deinterleaving. In this case, the channel deinterleaver 660 is interposed between the STC decoder 640 and the symbol-to-bit mapper 650.

In the structure of the receiver 600, given that the Alamouti space-time code has a coding rate of 1, the mobile station can decode data without a loss of data rate in a region adjacent to the base station, but not at a sector or cell boundary. At the sector or cell boundary, the mobile station obtains a sector or cell diversity gain as it receives space-time code streams from different sectors or cells. If an output pattern of the space-time code streams is controlled on a circular basis, the mobile station can periodically obtain sector diversity gain, and all of the mobile stations located at the cell or sector boundary can obtain the same sector diversity gain on average.

The sector diversity gain is instantaneously uniformly distributed to all of the mobile stations located at the cell or sector boundary through channel interleaving and deinterleaving, so that the mobile stations can obtain the uniform PER or BER performance. Therefore, embodiments of the present invention can efficiently increase the entire cell capacity or sector throughput without a separate device.

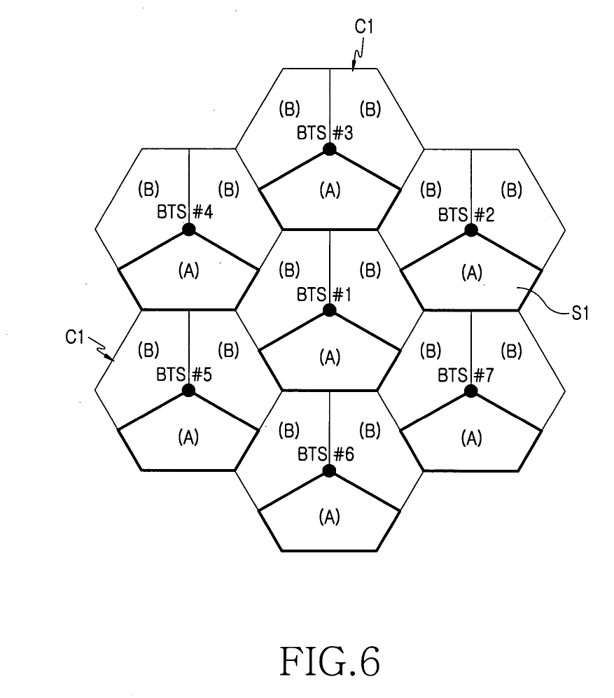

With reference to FIGS. 6 to 11, a description will now be made of a per-sector or cell space-time code stream arrangement method proposed in the present invention to acquire sector diversity.

FIGS. 6 to 11 are diagrams illustrating a per-sector space-time code stream arrangement method according to an embodiment of the present invention, wherein one cell C1 has a 3-sector structure S1.

The space-time code stream arrangement of FIGS. 6 to 11 is performed under the control of the selection controller 500 of FIG. 3, and the space-time code streams output to each sector C1 in this manner have a specific pattern. Alternatively, arrangement of the space-time code streams can be controlled directly by the selector 450 according to a parameter value provided from an upper layer, instead of being controlled by the selection controller 500.

In FIGS. 6 to 8, BTS#1 to BTS#7 represent base stations each forming 3 sectors, and (A) and (B) represent two space-time code streams {X₁, X₂} and {−X₂*, X₁*} or {X₁, −X₂*} and {X₂, X₁*}, respectively, output from the STC encoder 440 described in connection with FIGS. 4A and 4B.

If the selection controller 500 of FIG. 3 transmits a corresponding one of control signals S₁, S₂, . . . , S_{M} for selecting one of the space-time code streams to the selector 450 belonging to each sector, the selector 450 outputs a selected one of the time-space code streams (A) or (B) based on the corresponding control signal. In each sector, space-time code streams that are to be transmitted in the sector are selectively output as shown in FIGS. 6 to 8 according to the corresponding control signal, forming a specific per-cell pattern, and the pattern is changed for each update interval of the space-time code stream, thereby providing uniform sector diversity to the mobile station.

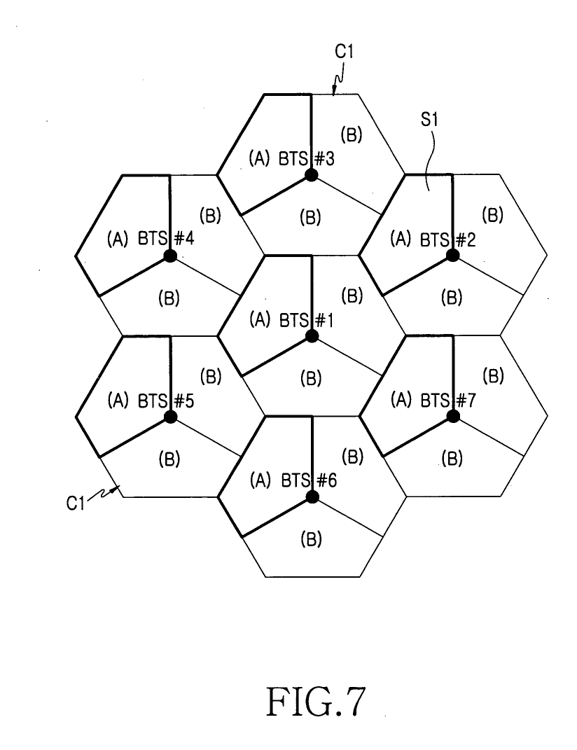

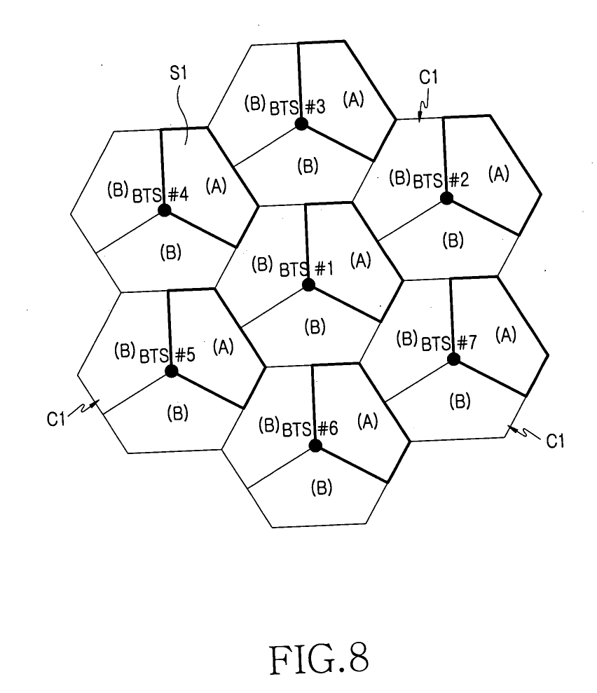

In FIGS. 6 to 8, each of the base stations BTS#1 to BTS#7 forms an output pattern of the same space-time code streams per cell by outputting the space-time code stream (A) to one sector and outputting the space-time code stream (B) to the other two sectors. The section controller 500 controls the selector 450 such that for the code stream selection period, an output pattern of space-time code streams is shifted in the cyclic order of FIG. 6→FIG. 7→FIG. 8→FIG. 6 or FIG. 6→FIG. 8→FIG. 7→FIG. 6. Herein, such a space-time code stream output scheme will be referred to as a “circular space-time code selection scheme.”

In the circular space-time code selection scheme, a full sector diversity gain occurs in a boundary between a sector where the space-time code stream (A) is transmitted and a sector where the space-time code stream (B) is transmitted, and the bold lines represent the sector boundaries where the full sector diversity gain occurs. Therefore, if output of the space-time code streams is controlled with the circular space-time code selection scheme, the position of the sector boundary where sector diversity occurs is periodically changed, so that uniform sector diversity gains can be provided to all of the mobile stations in the sector boundary.

Although the pattern shown in FIGS. 6 to 8 is formed such that in each cell, one sector outputs the space-time code stream (A) and the other two sectors output the space-time code stream (B), the same sector diversity can be obtained with a pattern formed such that one sector outputs the space-time code stream (B) and the other two sectors output the space-time code stream (A).

As another example of the per-sector space-time code stream arrangement method, there is a possible method of periodically changing an output pattern of the space-time code streams in the order of FIG. 6→FIG. 7→FIG. 6, in the order of FIG. 7→FIG. 8→FIG. 7, or in the order of FIG. 6→FIG. 8→FIG. 6. Although this method can provide improved sector diversity as compared with the conventional method, it cannot obtain sufficient sector diversity compared with the circular space-time code selection scheme.

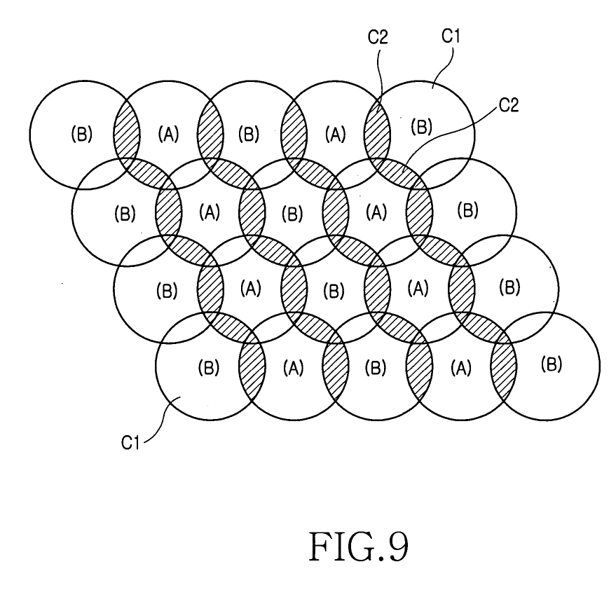

FIGS. 9 to 11 are diagrams for a description of a per-cell space-time code stream arrangement method according to an embodiment of the present invention, wherein each cell C1 transmits space-time code streams per cell using an omni-directional antenna without sectorization.

The space-time code stream arrangement of FIGS. 9 to 11 is also performed under the control of the selection controller 500 of FIG. 3, and the space-time code streams output to a plurality of cells C1 in this manner have a specific pattern. Alternatively, selection of the space-time code streams can be controlled using a parameter provided from an upper layer.

In FIGS. 9 to 11, (A) and (B) represent two space-time code streams {X₁, X₂} and {−X₂*, X₁*} or {X₁, −X₂*} and {X₂, X₁*}, respectively, output from the STC encoder 440 described in connection with FIGS. 4A and 4B, and regions C2 with oblique lines represent the regions where the full cell diversity gain occurs.

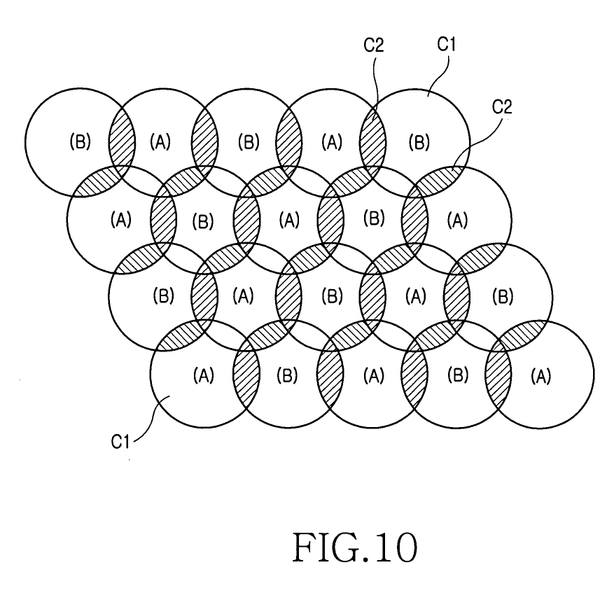

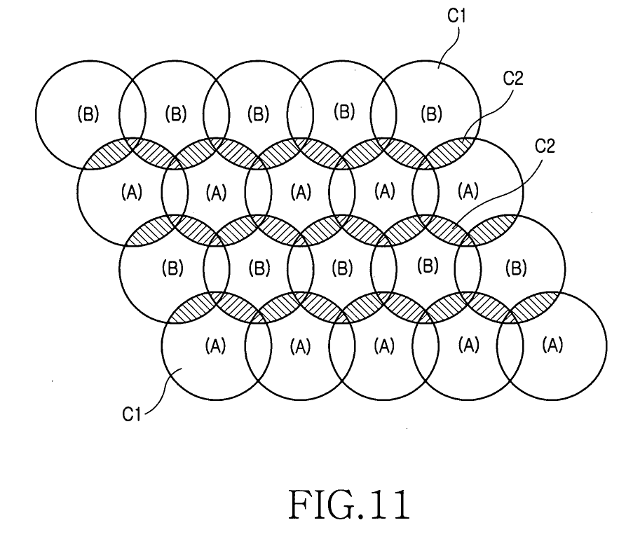

To form the patterns of FIGS. 9 to 11, the selection controller 500 controls a selector 450 of a base station that forms each cell C1 to select one of the space-time code streams (A) and (B) in the order of FIG. 9→FIG. 10→FIG. 11→FIG. 9 or FIG. 9→FIG. 11→FIG. 10→FIG. 9 every code stream selection period so that an output pattern of the space-time code streams is shifted on a cyclical, round-robin or circular basis. Therefore, it can be understood that if the output of the space-time code streams is controlled by the circular space-time code selection scheme, all of the mobile stations located in the cell boundary have the same cell diversity gain on average. In addition, even though each cell changes output of the space-time code stream (A) or (B) in FIGS. 9 to 11, the same cell diversity can be obtained.

As another per-cell space-time code stream arrangement method using an omni-directional antenna, there is an embodiment of a method for changing an output pattern of the space-time code streams in the order of FIG. 9→FIG. 10→FIG. 9, in the order of FIG. 10→FIG. 11→FIG. 10, or in the order of FIG. 9→FIG. 11→FIG. 9 every code stream selection period.

It should be noted that when the per-sector or cell space-time code stream arrangement method is performed, there is no need to transmit a separate control signal to a mobile station and the mobile station can restore the received data using one STC decoder.

In addition, because an output pattern of the space-time code streams is changed on a circular basis by the circular space-time code selection scheme, all of the mobile stations at the cell or sector boundary obtain the same sector or cell diversity gain on average, thereby maximizing the entire cell throughput.

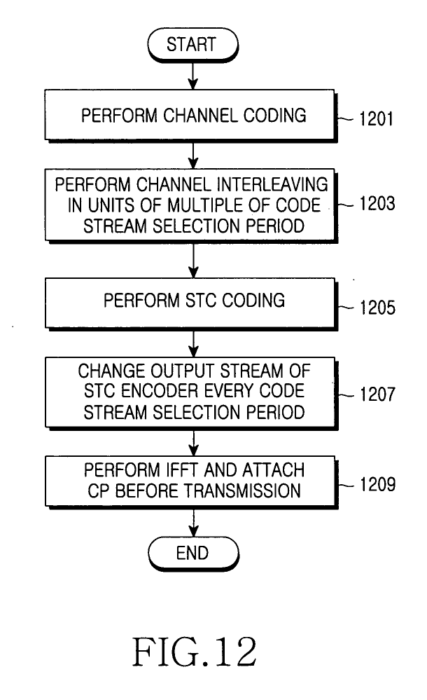

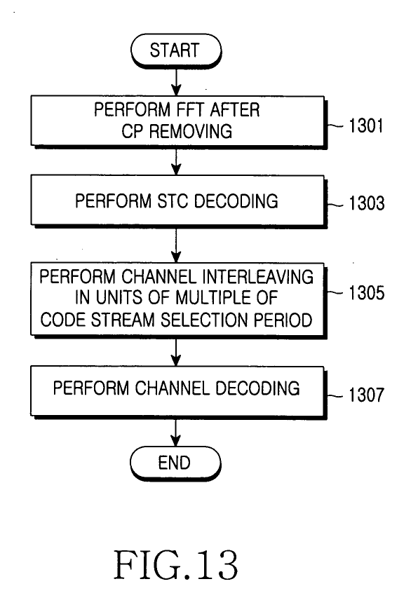

With reference to FIGS. 12 and 13, a description will now be made of an OFDM symbol transmission and reception method for providing sector diversity according to an embodiment of the present invention.

FIG. 12 is a flowchart illustrating an OFDM symbol transmission method for providing sector diversity according to an embodiment of the present invention. The OFDM symbol transmission method will be described with reference to the structure of FIG. 3.

In step 1201, the channel encoder 410 in the OFDM symbol transmission apparatus 400 channel-encodes transmission data. In step 1203, the channel interleaver 420 with a length N interleaves the coded transmission data and outputs the interleaved transmission data to the bit-to-symbol converter 430. Herein, the channel interleaver 420 performs interleaving in units of a multiple of a code stream selection period for a space-time code output from the selector 450, and the bit-to-symbol mapper 430 converts the interleaved transmission symbol bit stream into a complex symbol, and delivers the result to the STC encoder 440.

In step 1205, the STC encoder 440 performs STC coding on the input complex symbol preferably using an Alamouti space-time code, and outputs the coded space-time streams to the selector 450. In step 1207, the selector 450 selects one of the space-time code streams every code stream selection period under the control of the selection controller 500, and outputs the selected space-time code stream to the IFFT 460. Herein, one of the output space-time code streams is selected every code stream selection period such that the selected space-time code stream has an output pattern of, for example, one of FIGS. 6 to 8, or FIGS. 9 to 11. Alternatively, in step 1207, the selector 450 can control selection of the space-time code streams using a parameter value provided from an upper layer, instead of using the selection controller 500.

In step 1209, the IFFT 460 performs IFFT on the selected space-time code stream, and the CP adder 470 attaches a CP to the IFFT-processed space-time code stream, which can be an OFDM symbol, generating an OFDM symbol. The generated OFDM symbol is transmitted to a wireless network via the antenna 480.

According to another embodiment of the OFDM symbol transmission method of the present invention, a transmitter of a base station provides uniform sector diversity gain to mobile stations by controlling space-time code streams such that an output pattern of the space-time code streams is circulated at predetermined periods, and uniformly distributes sector diversity gain to all of the mobile stations located in a cell or sector boundary by performing channel interleaving on transmission data to be transmitted to the mobile stations.

FIG. 13 is a flowchart illustrating an OFDM symbol reception method for providing sector diversity according to an embodiment of the present invention. The OFDM symbol reception method according to an embodiment of the present invention will be described with reference to the structure of FIG. 5.

In step 1301, the CP remover 620 in the receiver 600 of the mobile station removes a CP from a received OFDM symbol, and the FFT 630 performs an FFT on the CP-removed OFDM symbol and outputs the resultant space-time code stream to the STC decoder 640. In step 1303, the STC decoder 640 performs STC decoding to restore the space-time code stream encoded with, for example, an Alamouti code, into a complex symbol. The symbol-to-bit mapper 650 converts the restored complex symbol into a bit stream, and outputs the bit stream to the channel deinterleaver 660.

In step 1305, the channel deinterleaver 660 performs channel deinterleaving on the input bit stream at the same period as the code stream selection period. In step 1307, the channel decoder 670 restores the received data by decoding the deinterleaved bit stream.

According to another embodiment of the OFDM symbol reception method, a mobile station receives uniformly distributed sector diversity gain at a cell or sector boundary. That is, in the embodiment of the present invention, parts where sector diversity gain occurs and parts where no sector diversity gain occurs are uniformly distributed on a per-channel decoding basis by interleaving and deinterleaving and the results are input to the channel decoder. As a result, the mobile station obtains the same PER and BER performance no matter at which sector boundary the mobile station is located.

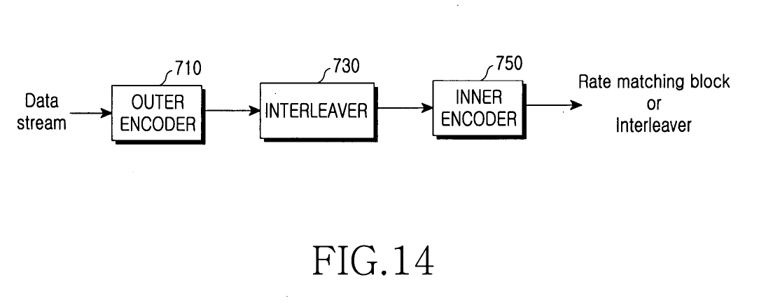

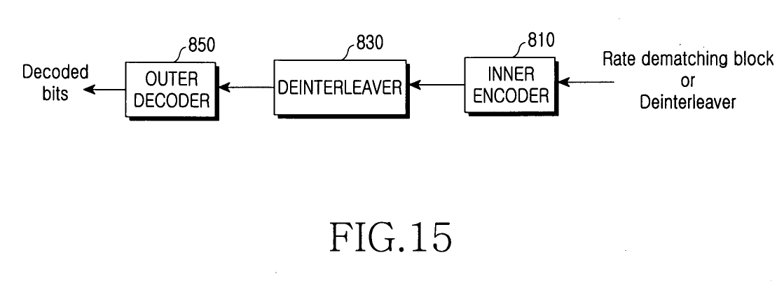

Various modifications of the present invention can be made herein without departing from the spirit and scope of the invention. For example, FIGS. 14 and 15 illustrate modifications of a concatenated channel encoder and a concatenated channel decoder for the channel encoder 410 and the channel decoder 670 shown in FIGS. 3 and 5, respectively. As illustrated in FIG. 14, the channel encoder 410 can be comprised of an outer encoder 710, an interleaver 730, and an inner encoder 750. For a broadcast service, a Reed-Solomon (RS) encoder can be used as the outer encoder 710, and the typical channel encoder can be used as the inner encoder 750.

As illustrated in FIG. 15, the channel decoder 670 can be comprised of an inner decoder 810, a deinterleaver 830, and an outer decoder 850. In this case, a general channel decoder can be used as the inner decoder 810, and an RS decoder can be used as the outer decoder 850. A length of the interleaver 730 and a length of the deinterleaver 830 are set to a multiple of the space-time code selection period. Similarly, in the structure of FIGS. 14 and 15, sector diversity gain is uniformly distributed by interleaving and deinterleaving, so that a decoded bit stream output from the outer decoder 850 provides the same PER and BER performance regardless of the position of the mobile station.

Although a length of the interleaver and deinterleaver is herein assumed to be set to a multiple of the code stream selection period, an increase in the length of the interleaver and deinterleaver increases uniformity of the instantaneous sector diversity gain no matter in which sector boundary the mobile station is located. Therefore, embodiments of the present invention exhibit a similar effect even for the case where the length of the interleaver and deinterleaver is set longer than the code stream selection period.

Finally, it should be noted that because the space-time coding applied to embodiments of the present invention have a coding rate of 1, data received from any one of the sectors can be demodulated without a change in reception performance. Therefore, for both broadcast data and unicast data, all subcarriers can be transmitted after being STC-encoded. In addition, as an STC decoder is applied to all subcarriers, the mobile station can receive data in any position in any cell, and can obtain improved sector diversity gain compared with the conventional one, especially at a sector or cell boundary.

As can be understood from the foregoing description, the present invention distributes sector diversity gain to all of the mobile stations located in a sector boundary by applying the circular space-time code selection scheme so that sector diversity gain is not concentrated on a mobile station located in a particular location. As a result, all of the mobile stations located at the sector boundary can obtain the same sector diversity gain on average.

In addition, as the sector diversity gain is instantaneously uniformly applied to mobile stations located at the sector boundary, a channel decoder in each of the mobile stations exhibits improved FER and BER performance and increased data rate at an output terminal thereof, thereby increasing the overall sector throughput.

Further, the improved sector diversity gain provided to the mobile stations contributes to an increase in the overall cell throughput and an average data rate.

Moreover, an output pattern of space-time code streams transmitted to mobile stations is changed every predetermined period on a circular basis, thereby providing uniformly improved sector diversity gain in a sector or cell boundary.

While the invention has been shown and described with reference to certain embodiments thereof, it will be understood by those skilled in the art that various changes in form and details may be made therein without departing from the spirit and scope of the invention as defined by the appended claims.

1. A method for transmitting by a base station an orthogonal frequency division multiplexing (OFDM) symbol to a mobile station in a wireless mobile communication system with a multicell and or multisector structure formed by a plurality of base stations, the method comprising the steps of:
interleaving data for transmission to the mobile station;
space-time coding (STC) the interleaved data and outputting a plurality of space-time code streams; and
selecting one of the space-time code streams every predetermined code stream selection period such that different space-time code streams are transmitted to at least one neighboring cell and or sector among cells and or sectors formed by the base station and other base stations, and transmitting the selected space-time code stream.

2. The method of claim 1, further comprising the step of circulating a transmission pattern of the space-time code streams every predetermined time period.

3. The method of claim 1, wherein the interleaving is performed in units of a multiple of the code stream selection period.

4. The method of claim 1, wherein the space-time coding step comprises the steps of:
STC-coding the data and outputting a plurality of space-time code streams;
selecting one of the space-time code streams; and
outputting the selected space-time code stream to a corresponding cell and or sector.

5. The method of claim 1, wherein the selection of the space-time code stream is controlled by a base station controller.

6. The method of claim 1, wherein each of the base stations has a 3-sector structure.

7. The method of claim 1, wherein each of the base stations forms an omni cell with an omni-directional antenna.

8. The method of claim 1, wherein the plurality of base stations form a single-frequency network.

9. The method of claim 1, wherein each of the plurality of base stations selects an output space-time code stream according to a predetermined control signal transmitted from an upper layer.

10. The method of claim 9, wherein the space-time coding uses an Alamouti space-time coding scheme defined as
$$C = [ \begin{matrix}{X}_{1} & {X}_{2} \\ - {X}_{2}^{*} & {X}_{1}^{*}\end{matrix} ]$$
where C denotes a coding matrix, and X₁ and X₂ denote the complex symbols input to an STC encoder.

11. An apparatus for transmitting by a base station an orthogonal frequency division multiplexing (OFDM) symbol to a mobile station in a wireless mobile communication system with a multicell/multisector structure formed by a plurality of base stations, the apparatus comprising:
an interleaver for interleaving data for transmission to the mobile station;
an space-time coding (STC) encoder for STC-coding the interleaved data and outputting a plurality of space-time code streams;
a selector for selecting one of the space-time code streams every predetermined code stream selection period such that different space-time code streams are transmitted to at least one neighboring cell or sector from among the cells or sectors formed by the base station and other base stations; and
a transmitter for generating an OFDM symbol using the space-time code stream output from the selector and transmitting the OFDM symbol to a wireless network.

12. The apparatus of claim 11, wherein the selector circulates a transmission pattern of the space-time code stream every predetermined time period.

13. The apparatus of claim 11, wherein a length of the interleaver is set to a multiple of the code stream selection period.

14. The apparatus of claim 11, wherein each of the plurality of base stations forms 3 sectors.

15. The apparatus of claim 11, wherein each of the plurality of base stations forms an omni cell with an omni-directional antenna.

16. The apparatus of claim 11, wherein the plurality of base stations form a single-frequency network.

17. The apparatus of claim 11, wherein each of the plurality of base stations selects an output space-time code stream according to a predetermined control signal transmitted from an upper layer.

18. The apparatus of claim 17, wherein the space-time coding uses an Alamouti space-time coding scheme defined as
$$C = [ \begin{matrix}{X}_{1} & {X}_{2} \\ - {X}_{2}^{*} & {X}_{1}^{*}\end{matrix} ]$$
where C denotes a coding matrix, and X₁ and X₂ denote the complex symbols input to an STC encoder.

19. An apparatus for receiving by a mobile station an orthogonal frequency division multiplexing (OFDM) symbol from a base station in a wireless mobile communication system with a multicell or multisector structure formed by a plurality of base stations, the apparatus comprising:
a space-time coding (STC) decoder for STC-decoding a space-time code stream obtained by performing a Fourier transform on the OFDM symbol;
a deinterleaver for deinterleaving the STC-decoded data; and
a channel decoder for channel-decoding the deinterleaved data into its original data.

20. The apparatus of claim 19, wherein a length of the deinterleaver is set to a multiple of a predetermined code stream selection period for which the base station selects outputs of an STC decoder.

21. An orthogonal frequency division multiplexing (OFDM) system with a multicell or multisector structure, the system comprising:
a plurality of base stations each including interleaving data for transmission to the mobile station, space-time coding (STC) the interleaved data into a plurality of space-time code streams, selecting one of the space-time code streams every predetermined code stream selection period such that different space-time code streams are transmitted to at least one neighboring cell and or sector among cells and or sectors formed by the base station and other base stations, and outputting the selected space-time code stream as an OFDM symbol; and
at least one mobile station for STC-decoding a space-time code stream obtained by performing Fourier transform on the OFDM symbol, deinterleaving the STC-decoded data, and channel-decoding the deinterleaved data into its original data.
